(19) United States
(12) Patent Application Publication
(10) Pub. No.: US 2025/0373403 A1
(43) Pub. Date: Dec. 4, 2025

(54) GRANULAR CONTROL CHANNEL MONITORING IN SUB-BAND NON-OVERLAPPING FULL DUPLEX

(71) Applicant: Lenovo (United States) Inc., Morrisville, NC (US)

(72) Inventors: Shwetha Sreejith, Steinbach (DE); Khaled Nafez Rauf Ardah, Schwieberdingen (DE); Joachim Löhr, Wiesbaden (DE)

(21) Appl. No.: 19/232,410

(22) Filed: Jun. 9, 2025

(51) Int. Cl. H04L 5/14; H04L 5/00; H04L 27/26; H04W 76/28

(52) U.S. Cl. CPC H04L 5/1438; H04L 5/0044; H04L 27/2607; H04L 27/2666; H04W 76/28

(57) ABSTRACT

A user equipment (UE) receives a configuration for sub-band full duplex (SBFD) comprising one or more of downlink (DL) sub-bands, uplink (UL) sub-bands. The UE refrains from monitoring a physical downlink control channel (PDCCH) during a duration associated with an UL sub-band based at least in part on the received configuration for SBFD.

### TECHNICAL FIELD

The present disclosure relates to wireless communications, and more specifically to managing monitoring of control channels in sub-band non-overlapping full duplex (SBFD).

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive a configuration for sub-band full duplex (SBFD) comprising one or more of downlink (DL) sub-bands, uplink (UL) sub-bands. The UE is further to refrain from monitoring a physical downlink control channel (PDCCH) during a duration associated with an UL sub-band based at least in part on the received configuration for SBFD.

In some implementations, the one or more processors are further individually or collectively operable to cause the UE to receive an indication to skip monitoring the PDCCH, wherein to refrain monitoring the PDCCH is based at least in part on the received indication to skip monitoring the PDCCH.

In some implementations, the one or more processors are further individually or collectively operable to cause the UE to jointly receive the configuration for SBFD and the indication to skip monitoring the PDCCH.

In some implementations, the indication to skip monitoring the PDCCH is indicative of one or more skipping conditions, and wherein the one or more processors are further individually or collectively operable to cause the UE to determine that at least one of the one or more skipping conditions has been satisfied. In some implementations, the one or more skipping conditions comprise a minimum UL sub-band size, a DL traffic type; or a Time Division Duplex (TDD) configuration.

In some implementations, one or more of the configuration for SBFD or the indication to skip monitoring the PDCCH is received in system information (SI) message, a Radio Resource Control (RRC) message, or a downlink control information (DCI). In some implementations, the indication to skip monitoring the PDCCH is received in DCI, wherein a Cyclic Redundancy Check (CRC) of the DCI is scrambled based on a Radio Network Temporary identifier (RNTI). In some implementations, the RNTI is associated with the UE or a group of UEs.

In some implementations, the one or more processors are further individually or collectively operable to cause the UE to perform a discontinuous reception (DRX) operation associated with a connected mode DRX based at least in part on absence of an indication to skip monitoring the PDCCH after reception of the configuration for SBFD.

In some implementations, to refrain from monitoring the PDCCH, the one or more processors are further individually or collectively operable to cause the UE to activate a sleep mode of the UE for the duration, wherein the sleep mode of the UE comprises: a micro-sleep mode, a light-sleep mode, a deep-sleep mode, or an ultra-deep sleep mode.

In some implementations, the duration associated with the UL sub-band comprises a duration of a time-frequency resource, comprising a symbol, a slot, a RB, or a BWP.

In some implementations, to refrain from monitoring the PDCCH for the duration of the UL sub-band, the one or more processors are further individually or collectively operable to cause the UE to stop, for the duration of the UL sub-band, a DRX timer associated with an active time of the DRX, wherein stopping the DRX timer causes the UE to refrain from monitoring the PDCCH for the duration of the UL sub-band.

In some implementations, the UE is configured with a first set of BWPs for UL and a second set of BWPs for DL, wherein the UL sub-band corresponds to one or more of the second set of BWPs for DL, and wherein, to refrain from monitoring the PDCCH for the duration of the UL sub-band, the one or more processors are further individually or collectively operable to cause the UE to identify one or more BWPs of the second set of BWPs for DL that occurs during a DRX active time, and deactivate the one or more BWPs that occurs during the DRX active time.

In another embodiment, a method performed or performable by a UE comprises receiving, by the UE from a network entity, configuration for SBFD comprising one or more of DL sub-bands, UL sub-bands. The method includes refraining from monitoring a PDCCH during a duration associated with an UL sub-band based at least in part on the received configuration for SBFD.

In another embodiment, a network entity for wireless communication is described, including one or more memories and one or more processors coupled with the one or more memories. The one or more processors are individually or collectively operable to cause the network entity to determine a SBFD configuration comprising one or more of DL sub-bands, UL sub-bands. The NE is further to send, to one or more UEs, the SBFD configuration and an indication to skip monitoring the PDCCH during a duration of an UL sub-band.

In some implementations, the indication to skip monitoring the PDCCH is indicative of one or more skipping conditions.

In some implementations, the one or more skipping conditions comprise a minimum UL sub-band size, a DL traffic type; or a TDD configuration.

In some implementations, one or more of the configuration for SBFD or the indication to skip monitoring the PDCCH is sent in SI message, a RRC message, or a DCI.

In some implementations, the indication to skip monitoring the PDCCH is sent in DCI, wherein a CRC of the DCI is scrambled based on a RNTI. In some implementations, the RNTI is associated with at least one of the one or more UEs.

### BRIEF DESCRIPTION OF THE DRAWINGS

FIG. 1 illustrates an example of a wireless communications system in accordance with aspects of the present disclosure.

FIG. 2 is a communication flow diagram for granular control channel skipping decisions in sub-band non-overlapping full duplex (SBFD) in accordance with aspects of the present disclosure.

FIG. 3 is a communication flow diagram for granular control channel skipping decisions in SBFD with shared or group-specific discontinuous reception (DRX) configuration in accordance with aspects of the present disclosure.

FIG. 4 is a communication flow diagram for granular control channel skipping decisions in SBFD with explicit physical downlink control channel (PDCCH) skipping configuration signaling in accordance with aspects of the present disclosure.

FIG. 5 illustrates an example of a user equipment (UE) in accordance with aspects of the present disclosure.

FIG. 6 illustrates an example of a processor in accordance with aspects of the present disclosure.

FIG. 7 illustrates an example of a network entity (NE) in accordance with aspects of the present disclosure.

FIG. 8 illustrates a flowchart of a method performed by a UE in accordance with aspects of the present disclosure.

FIG. 9 illustrates a flowchart of a method performed by a NE in accordance with aspects of the present disclosure.

### DETAILED DESCRIPTION

The present disclosure describes technology related to power-saving operation in user equipment (UE) for wireless networks using sub-band non-overlapping full duplex (SBFD) configurations with connected mode discontinuous reception (DRX). In conventional DRX procedures, an SBFD-aware UE may continuously monitor the Physical Downlink Control Channel (PDCCH) during DRX active times, even when only uplink (UL) sub-bands are active and no downlink (DL) data is expected. For example, this can lead to the UE being awake and consuming unnecessary power even when no DL reception is possible in the associated time-frequency resources.

More specifically, time-division duplexing (TDD) is widely used in commercial Fifth Generation (5G) New Radio (NR) deployments. In TDD, the time domain resource is split between downlink and uplink. Allocation of a limited time duration for the uplink in TDD would result in reduced coverage, increased latency and reduced capacity. As such, approaches such as SBFD have been developed to enable the simultaneous utilization of downlink and uplink (i.e., full duplex).

During a discontinuous reception (DRX) cycle, the UE is configured with one or more timers that dictate the monitoring of PDCCH in the downlink (e.g., drx-onDuration Timer, drx-Inactivity Timer, etc.). While this timer is running, the UE monitors the PDCCH channel for any DL receptions. When a UE is configured with SBFD operation, one or more of the DL symbols may be configured with a UL sub-band such that the SBFD-aware UEs can utilize this UL sub-band for UL transmission. According to conventional DRX procedures, a SBFD-aware UE remains awake (i.e., continues monitoring) while the DRX timer(s) are running, regardless of whether any UL sub-band overlaps with the timer. In other words, a SBFD-aware UE will monitor PDCCH during a configured UL sub-band even if no DL reception is scheduled for reception. In turn, the UE actively monitoring the PDCCH when monitoring is not needed can waste substantial computing resources (e.g., power, memory, battery or energy, network resources, etc.).

Accordingly, implementations described herein propose granular control channel skipping decisions in SBFD. More specifically, a Network Entity (NE) (e.g., base station, virtual network function (VNF)) can determine a SBFD configuration for a UE. The “UE” can be any type of device, such as a user device, an internet-of-things (IoT) device, etc. that includes a transceiver operable for transmission and reception in connected mode DRX over time-frequency resources that are associated with DL sub-bands or UL sub-bands according to an SBFD configuration.

The NE can signal the SBFD configuration to the UE. In some implementations, the NE can also signal an indication to skip monitoring the PDCCH to the UE. For example, the NE may signal the SBFD configuration and the indication to skip monitoring the PDCCH to the UE on the same signal. For another example, the NE may signal the SBFD configuration to the UE with a first signal and then signal the indication to skip monitoring the PDCCH to the UE via a second signal (e.g., radio resource control (RRC) signaling, downlink control information (DCI) signaling). Alternatively, in some implementations, the UE can determine the indication to skip monitoring the PDCCH based on the SBFD configuration received from the NE.

The indication to skip monitoring the PDCCH, whether received or determined by the UE, can indicate UL sub-band, and/or a time-frequency resource (e.g., a symbol, a slot, a resource block (RB), a bandwidth part (BWP)) that is associated with the UL sub-band from among a plurality of time-frequency resources included in (or otherwise indicated by) the SBFD configuration. Based on the indication to skip monitoring the PDCCH, the UE can refrain from monitoring the PDCCH for a duration of the UL sub-band (or the time-frequency resource associated with the UL sub-band).

Aspects of the present disclosure provide technical improvements by enabling the UE to dynamically skip monitoring the physical downlink control channel (PDCCH) during specified uplink sub-band resources within SBFD operation. This selective deactivation of PDCCH monitoring at the UE is enabled via explicit or implicit signaling from the network. By allowing the UE to enter a non-active mode (e.g., a low-power mode, a “sleep” mode, etc.) during these intervals, the overall consumption of computing resources by the UE can be reduced significantly (e.g., power, memory, compute cycles, energy, etc.), therefore enabling extended battery life for mobile devices.

Further, implementations described herein provide granular control of PDCCH monitoring by enabling monitoring decisions to be made at varying time-frequency resource resolutions, such as individual symbols, slots, RBs, or BWPs. For example, the network can configure PDCCH skipping for specific resource segments through RRC signaling or specifically configured DCI. This level of configurability ensures that power-saving mechanisms are not applied indiscriminately but are instead tightly coupled to the actual transmission and reception patterns of the device. As a result, device resources can be managed with fine precision, preventing wasteful monitoring and leveraging the radio's state management capabilities to achieve measurable efficiency improvements in real network deployments.

It should be noted that implementations described herein may also be applied to other types of DL monitoring, such as reception in DL physical downlink shared channel (PDSCH), in order to further optimize resource utilization.

Aspects of the present disclosure are described in the context of a wireless communications system. Additionally details of one or more implementations of the present disclosure are set forth in the accompanying drawings and the description below. Other aspects and advantages will become apparent from the description, the drawings, and the claims.

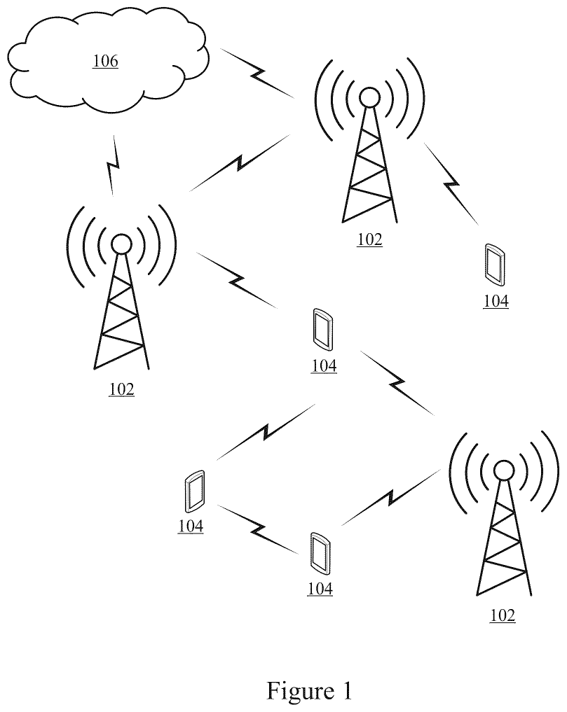

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

In some implementations, an NE 102 may be implemented in a disaggregated architecture (e.g., a disaggregated base station architecture, a disaggregated RAN architecture), which may be configured to utilize a protocol stack that may be physically or logically distributed among multiple network entities (e.g., NEs 102), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, an NE 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), or any combination thereof. An RU may also be referred to as a radio head, a smart radio head, a remote radio head (RRH), a remote radio unit (RRU), or a transmission reception point (TRP). The split of functionality between a CU, a DU, and an RU may be flexible and may support different functionalities depending on which functions (e.g., network layer functions, protocol layer functions, baseband functions, RF functions, or any combinations thereof) are performed at a CU, a DU, or an RU.

One or more components of the NEs 102 in a disaggregated RAN architecture may be co-located, or one or more components of the NEs 102 may be located in distributed locations (e.g., separate physical locations). Additionally, or alternatively, in some examples, one or more of the NEs 102 of a disaggregated RAN architecture may be implemented as virtual units (e.g., a virtual CU (VCU), a virtual DU (VDU), a virtual RU (VRU)).

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

The wireless communications system 100 may be configured to support ultra-reliable communications or low-latency communications, or various combinations thereof. For example, the wireless communications system 100 may be configured to support ultra-reliable low-latency communications (URLLC). The UEs 104 may support ultra-reliable, low-latency, or critical functions. Ultra-reliable communications may include private communication or group communication. Support for ultra-reliable, low-latency functions may include prioritization of services, and such services may be used for public safety or general commercial applications. The terms ultra-reliable, low-latency, and ultra-reliable low-latency may be used interchangeably herein.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a CP. A first numerology (e.g., μ=0) may be associated with a first subcarrier spacing (e.g., 15 kHz) and a normal CP. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal CP. A third numerology (e.g., μ=2) may be associated with a third subcarrier spacing (e.g., 60 kHz) and a normal CP or an extended CP. A fourth numerology (e.g., μ=3) may be associated with a fourth subcarrier spacing (e.g., 120 kHz) and a normal CP. A fifth numerology (e.g., μ=4) may be associated with a fifth subcarrier spacing (e.g., 240 kHz) and a normal CP.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal CP, a slot may include 15 symbols. For an extended CP (e.g., applicable for 60 kHz subcarrier spacing), a slot may include 12 symbols. The relationship between the number of symbols per slot, the number of slots per subframe, and the number of slots per frame for a normal CP and an extended CP may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some implementations, the UE 104 can be a UE that includes a transceiver operable for transmission and reception in connected mode DRX over time-frequency resources that are associated with one or more of DL sub-bands or UL sub-bands according to a SBFD configuration. For example, the UE 104 may be a Fifth Generation (5G) New Radio (NR) capable device that supports SBFD, a Sixth Generation (6G) device that supports SBFD, etc.

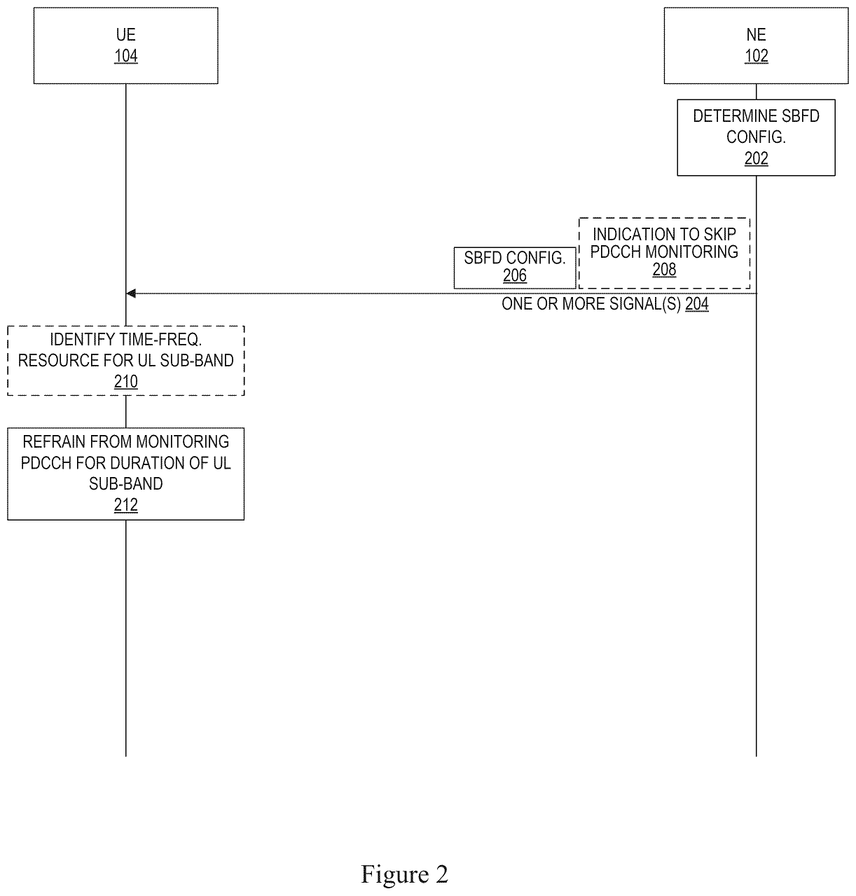

FIG. 2 is a communication flow diagram for granular control channel skipping decisions in SBFD in accordance with aspects of the present disclosure. FIG. 2 will be discussed in conjunction with FIG. 1. More specifically, at 202, the NE 102 can determine a SBFD configuration 206 for the UE 104 (or a group of UEs including the UE 104). The SBFD configuration 206 can be any type of SBFD configuration, such as SBFD configuration 1 or configuration 2. Specifically, in some implementations, the NE 102 can configure the UE 104 (or the UE can already be configured for) SBFD configuration 1 or SBFD configuration 2. At 202, the NE 102 can determine the SBFD configuration 206 based on the SBFD configuration type (e.g., configuration 1 or 2) for which the UE 104 is configured. In other words, if the UE 104 is configured for SBFD configuration 1, the UE 104 can provide an SBFD configuration 1 for the UE 104. If the UE 104 is configured for SBFD configuration 2, the UE 104 can provide an SBFD configuration 2 for the UE 104.

For UL transmissions and DL receptions across SBFD symbols and non-SBFD symbols in different slots, the transmissions and/or receptions are restricted to SBFD symbols only or non-SBFD symbols only. When the UE 104 is configured with SBFD configuration 1 and DRX in RRC Connected Mode, the UE monitors PDCCH for DL reception based on either one of the DL sub-bands in SBFD symbols or one of the non-SBFD DL symbols within a slot. During active time (e.g., while DRX timers such as drx-onDuration or drx-Inactivity timer are running), the SBFD-aware UE 104 may be monitoring for PDCCH in SBFD symbols that are configured with UL sub-bands. In other words, the SBFD-aware UE 104 may consume computing resources (e.g., power, memory, compute cycles) to monitor for PDCCH even within those time-frequency resources where a UL sub-band is configured, even though the NE 102 would not transmit any DL data within those time-frequency resources associated with the UL sub-band.

For SBDF configuration 2, UL transmissions and DL receptions across SBFD symbols and non-SBFD symbols can be different slots, and each transmission/reception within a slot can include either all SBFD or all non-SBFD symbols. When a SBFD-aware UE such as the UE 104 is configured with SBFD configuration 2 and DRX in RRC Connected Mode, the UE 104 can monitor PDCCH for DL reception on both the configured DL sub-bands in SBFD symbols and on the non-SBFD DL symbols. During active time (e.g., while drx-onDuration or drx-Inactivity timer is running), the SBFD-aware UE may still be monitoring for PDCCH in SBFD symbols that are configured with UL sub-bands.

In some implementations, if the UE 104 is configured with SBFD configuration 2, the valid symbol type for PDCCH monitoring can be determined based on the first symbol type (e.g., SBFD symbol or non-SBFD symbol) where PDCCH monitoring starts (e.g., according to DRX-related timers). In some implementations, the valid symbol type may be determined based on the first symbol type where the UE receives DL scheduling on the PDCCH channel (e.g., where a valid DCI is received). A “valid” symbol type can refer to the type of symbol (e.g., SBFD symbols or non-SBFD symbols) within a slot in which the UE 104 is required to monitor PDCCH.

At 204, the NE 102 can send the SBFD configuration 206 to the UE 104 (e.g., via one or more signals). In some implementations, the NE 102 can also send a indication to skip PDCCH monitoring 208 to the UE 104 (e.g., via one or more signals). For example, the NE 102 may transmit a first signal including the SBFD configuration 206 and the indication to skip PDCCH monitoring. For another example, the NE 102 may send a first signal including the SBFD configuration 206 and send a second signal including the indication to skip PDCCH monitoring 208. For yet another example, the UE 104 may determine the indication to skip PDCCH monitoring 208 based on the received SBFD configuration 206.

In some implementations, the indication to skip PDCCH monitoring 208 can indicate a UL sub-band (or a time-frequency resource associated with a UL sub-band) of the SBFD configuration. The indication to skip PDCCH monitoring 208 can be configured such that, when the UE 104 receives (or decodes) the indication to skip PDCCH monitoring, the UE 104 stops monitoring of PDCCH for the duration of the UL sub-band (or the time-frequency resource associated with the UL sub-band, such as a symbol, slot, BWP, etc.) after the end of the last time-frequency resource.

For example, assume the indication to skip PDCCH monitoring 208 is signaled via a DCI signal to the UE 104. The RB set indicator field within DCI format 2_0 may be leveraged to indicate those time-frequency resources (e.g., RBs) that correspond to UL sub-band(s) as unavailable. In some implementations, the UE 104 can be assigned a new radio network temporary identifier (RNTI) (e.g., SBFD-RNTI). The cyclic redundancy check (CRC) of the DCI can be scrambled with the RNTI. The RNTI may be provided to the UE or a group of SBFD-aware UEs. In such fashion, the UE 104 can determine that a received indication to skip PDCCH monitoring is addressed to the UE 104 (or a group of UEs).

In some implementations, the indication to skip PDCCH monitoring 208 can be, or can otherwise be included in, an RRC information element (IE). For example, the below DownlinkConfigCommon IE (e.g., an IE provided via RRC signaling, etc.) is provided as a non-limiting example of an IE that can be used to convey the PDCCH skipping configuration to the UE 104:

| | |
|---|---|
| ASN1START | |
| TAG-DOWNLINKCONFIGCOMMONIB-START | |
| DownlinkConfigCommonSIB : := | SEQUENCE { |
| FrequencyInfoDL | FrequencyInfoDL-SIB, |
| IntialDownlinkBWP | BWP-Downlinkcommon, |
| Bcch-Config | BCCH-Config, |
| Pcch-Config | PCCH-Config, |
| . . ., | |
| [ [ | |
| pei-Config-r17 | PEI-Config-r17 |
| OPTIONAL, -- Need R | |
| intialDownlinkBWP-RedCap-r17 | BWP-DownlimkCommon |
| OPTIONAL -- Need R | |
| ] ], | |
| [ [ | |
| FrequencyInfoDL-v1800 | FrequencyInfoDL-v1800 |
| OPTIONAL -- Need R | |
| ] ], | |
| } | |
| DownlinkConfigCommonSIB-v1760 : := | SEQUENCE { |
| FrequencyInfoDL-v1760 | FrequencyInfoDL-SIB-v1760 |
| } | |
| BCCH-CONFIG : := | SEQUENCE { |
| MoficationPeriodCoeff | ENUMERATED {n2, n4, |
| n8, n16}, | |
| . . . | |
| } | |
| PCCH-Config : := | SEQUENCE { |
| defaultPagingCycle | PagingCycle, |
| nAndPagingFrameOfdset | CHOICE { |
| oneT | NULL, |
| halfT | INTEGER |
| (0..1), | |
| quartersT | INTEGER |
| (0..3), | |
| oneEighthT | INTEGER |
| (0..7), | |
| oneSixteenthT | INTEGER |
| (0..15) | |
| }, | |
| Ns | ENUMERATED |
| {four, two, one}, | |
| firstPDCCH-MonitoringOccasionOfPO | CHOICE { |
| sCS15KHZoneT | |
| SEQUENCE (SIZE (1..maxPO-perPF) ) OF INTEGER (0..139), | |
| sCS30KHZoneT-sSC15KHZhalfT | |
| SEQUENCE (SIZE (1..maxPO-perPF) ) OF INTEGER (0..279), | |
| sCS60KHZoneT-SCS30KHZhalfT-SCS15KHZquarterT | |
| SEQUENCE (SIZE (1..maxPO-perPF) ) OF INTEGER (0..559), | |
| sCS120KHZoneT-SCS60KHZhalfT-SCS30KHZquarterT | |
| SCS15KHZoneEighthT SEQUENCE (SIZE (1..maxPO- | |
| perPF) ) OF INTEGER (0..1119), | |
| sCS120KHZhalfT-SCS60KHZquarterT-SCS60KHZoneEighthT- | |
| SCS15KHZoneSixteenthT SEQUENCE (SIZE (1..maxPO- | |
| PERPF) ) OF INTEGER (0..2239), | |
| sCS480KHZoneT-SCS120KHZquarterT-SCS60KHZoneEighthT- | |
| SCS30KHZoneSixteenthT SEQUENCE (SIZE (1..maxPO- | |
| PERPF) ) OF INTEGER (0..4479), | |
| sCS480KHZalfT-SCS120KHZoneEighthT- | |
| SCS15KHZoneSixteenthT SEQUENCE (SIZE (1..maxPO- | |
| PERPF) ) OF INTEGER (0..8959), | |
| sCS480KHZquarterT-SCS120KHZoneEighthT | |
| SEQUENCE (SIZE (1..MAXPO-PERPF) ) OF INTEGER (0..17919) | |
| } OPTIONAL, -- Need R | |
| . . ., | |
| [ [ | |
| nrofPDCCH-MonitoringOccasionPerSSB-InPO-r16 | |
| INTEGER (2..4) OPTIONAL -- Cond Shared Spectrum2 | |
| ] ], | |
| [ [ | |
| ranPagingInIdlePO-r17 | |
| ENUMERATED {true} OPTIONAL, -- Need R | |
| firstPDCCH-MonitoringOccasionOfPO-v1710 | CHOICE { |
| sCS480KHZoneEighthT | SEQUENCE (SIZE |
| (1..maxPO-perPF) ) OF INTEGER (0..35839), | |
| sCS480KHZoneSixteenthT | SEQUENCE (SIZE |
| (1..maxPO-perPF) ) OF INTEGER (0..71679) | |
| } | |
| OPTIONAL -- Need R | |
| ] ] | |
| } | |
| PEI-onfig-r17 : := | SEQUENCE { |
| po-NumPerPEI-r17 | ENUMERATED |
| {po1, po2, po4, po8}, | |
| payloadSizeDCI-2-7-r17 | INTEGER |
| (1..maxDCI-2-7-Size-r17), | |
| pei-FrameOffset-r17 | INTEGER |
| (0..16), | |
| subgroupConfig-r17 | |
| SubgroupConfig-r17, | |
| lastUsedCellOnly-r17 | ENUMERATED |
| {true} | |
| OPTIONAL, -- Need R | |
| . . . | |
| } | |
| SubgroupConfig-r17 : := SEQUENCE { | |
| subgroupsNumPerPO-r17 INTEGER (1.. | |
| maxNrofPagingSubgroups-r17), | |
| subgroupsNumForUEID-r17 INTEGER (1.. | |
| maxNrofPagingSubgroups-r17) | |
| OPTIONAL, -- Need S | |
| . . . | |
| } | |
| SBFD-Config : := | SEQUENCE { |
| InactiveSBFD-r20 | ENUMERATED {TRUE} |
| OPTIONAL | |
| } | |
| TAG-DOWNLINKCONFIGCOMMONSIB-STOP | |
| ASN1STOP | |

Alternatively, in some implementations, the indication to skip PDCCH monitoring 208 can be, or can otherwise be included in, a DRX IE. For example, the below DRX-Config IE (e.g., an IE provided via DRX configuration, etc.) is provided as a non-limiting example of an IE that can be used to convey the indication to skip PDCCH monitoring 208 to the UE 104:

| | |
|---|---|
| DRX-Config : := | SEQUENCE { |
| drx-onDurationTimer | CHOICE { |
| subMilliSeconds INTEGER (1..31), | |
| | milliSeconds |
| ENUMERATED { | |
| | ms1, |
| ms2, ms3, ms4, ms5, ms6, ms8, ms10, ms20, ms30, ms40, | |
| ms50, ms60, | |
| | ms80, |
| ms100, ms200, ms300, ms400, ms500, ms600, ms800, ms1000, | |
| ms1200, | |
| | ms1600, |
| spare8, spare7, spare6, spare5, spare4, spare3, spare2, | |
| spare1 } | |
| | }, |
| drx-InactivityTimer | ENUMERATED { |
| | ms0, ms1, |
| ms2, ms3, ms4, ms5, ms6, ms8, ms10, ms20, ms30, ms40, | |
| ms50, ms60, ms80, | |
| | ms100, |
| ms200, ms300, ms500, ms750, ms1280, ms1920, ms2560, | |
| spare9, spare8, | |
| | spare7, |
| spare6, spare5, spare4, spare3, spare2, spare1}, | |
| drx-HARQ-RTT-TimerDL | INTEGER (0..56), |
| drx-HARQ-RTT-TimerUL | INTEGER (0..56), |
| drx-RetransmissionTimerDL | ENUMERATED { |
| | s10, s11, |
| sl2, sl4, sl6, sl8, sl16, sl24, sl33, sl40, sl64, sl80, | |
| sl96, sl112, sl128, | |
| | sl160, |
| sl320, spare15, spare14, spare13, spare12, spare11, | |
| spare10, spare9, | |
| | spare8, |
| spare7, spare6, spare5, spare4, spare3, spare2, spare1}, | |
| drx-RetransmissionTimerUL | ENUMERATED { |
| | sl0, sl1, |
| sl2, sl4, sl6, sl8, sl16, sl24, sl33, sl40, sl64, sl80, | |
| sl96, sl112, sl128, | |
| | sl160, |
| sl320, spare15, spare14, spare13, spare12, spare11, | |
| spare10, spare9, | |
| | spare8, |
| spare7, spare6, spare5, spare4, spare3, spare2, spare1 | |
| }, | |
| drx-LongCycleStartOffset | CHOICE { |
| ms10 | |
| INTEGER (0..9), | |
| ms20 | |
| INTEGER (0..19), | |
| ms32 | |
| INTEGER (0..31), | |
| ms40 | |
| INTEGER (0..39), | |
| ms60 | |
| INTEGER (0..59), | |
| ms64 | |
| INTEGER (0..63), | |
| ms70 | |
| INTEGER (0..69), | |
| ms80 | |
| INTEGER (0..79), | |
| ms128 | |
| INTEGER (0..127), | |
| ms160 | |
| INTEGER (0..159), | |
| ms256 | |
| INTEGER (0..255), | |
| ms320 | |
| INTEGER (0..319), | |
| ms512 | |
| INTEGER (0..511), | |
| ms640 | |
| INTEGER (0..639), | |
| ms1024 | |
| INTEGER (0..1023), | |
| ms1280 | |
| INTEGER (0..1279), | |
| ms2048 | |
| INTEGER (0..2047), | |
| ms2560 | |
| INTEGER ( 0..2559), | |
| ms5120 | |
| INTEGER (0..5119), | |
| ms10240 | |
| INTEGER (0..10239) | |
| }, | |
| shortDRX | SEQUENCE { |
| drx-ShortCycle | ENUMERATED |
| { | |
| | ms2, |
| ms3, ms4, ms5, ms6, ms7, ms8, ms10, ms14, ms16, ms20, | |
| ms30, ms32, | |
| | ms35, |
| ms40, ms64, ms80, msl28, msl60, ms256, ms320, ms512, | |
| ms640, spare9, | |
| | spare8, |
| spare7, spare6, spare5, spare4, spare3, spare2, spare1 | |
| }, | |
| drx-ShortCycleTimer | INTEGER |
| (1..16) | |
| } | |
| OPTIONAL, -- Need R | |
| drx-SlotOffset | INTEGER (0..31) |
| } | |
| DRX-ConfigExt-v1700 : := | SEQUENCE { |
| drx-HARQ-RTT-TimerDL-r17 | INTEGER |
| (0..448), | |
| drx-HARQ-RTT-TimerUL-r17 | INTEGER |
| (0..448) | |
| } | |
| DRX-ConfigExt2-v1800 : := | SEQUENCE { |
| drx-NonIntegerLongCycleStartOffset-r18 | CHOICE |
| ms1001over240 INTEGER (0..3), | |
| ms25over6 INTEGER (0..3), | |
| ms25over3 INTEGER (0..7), | |
| ms1001over120 INTEGER (0..7), | |
| ms100over9 INTEGER (0..10), | |
| ms25over2 INTEGER (0..11), | |
| ms40over3 INTEGER (0..12), | |
| ms125over9 INTEGER (0..12), | |
| ms50over3 INTEGER (0..15), | |
| ms1001over60 INTEGER (0..15), | |
| ms125over6 INTEGER (0..19), | |
| ms200over9 INTEGER (0..21), | |
| ms250over9 INTEGER (0..26), | |
| ms100over3 INTEGER (0..32), | |
| ms1001over30 INTEGER (0..32), | |
| ms75over2 INTEGER (0..36), | |
| ms125over3 INTEGER (0..40), | |
| ms1001over24 INTEGER (0..40), | |
| ms200over3 INTEGER (0..65), | |
| ms1001over15 INTEGER (0..65), | |
| ms250over3 INTEGER (0..82), | |
| ms1001over12 INTEGER (0..82), | |
| ms400over3 INTEGER (0..132), | |
| . . . | |
| }, | |
| shortDRX-r18 | SEQUENCE { |
| drx-NonIntegerShortCycle-r18 | |
| ENUMERATED {ms1001over240, ms25over6, ms25over3, | |
| ms1001over120, ms100over9, ms25over2, | |
| ms40over3, ms125over9, ms50over3, ms1001over60, | |
| ms125over6, ms200over9, | |
| ms100over3, ms1001over30, ms125over3, ms1001over24, | |
| ms200over3, spare15, | |
| spare14, spare13, spare12, spare11, spare10, spare9, | |
| spare8, spare7, spare6, | |
| spare5, spare4, spare3, spare2, spare1}, | |
| drx-ShortCycleTimer-r18 | INTEGER |
| (1..16) | |
| } | |
| OPTIONAL, -- Need R | |
| drx-TimeReferenceSFN-r18 | |
| ENUMERATED {sfn512} | |
| OPTIONAL -- Need S | |
| } | |
| SBFD-Config : := | SEQUENCE { |
| drx-InactiveSBFD-r20 | |
| ENUMERATED {true} | |
| OPTIONAL | |
| } | |
| TAG-DRX-CONFIG-STOP | |
| ASN1STOP | |

At 210, in some implementations, the UE 104 can identify the UL sub-band (or the time-frequency resource for the UL sub-band) identified by the indication to skip PDCCH monitoring 208. Specifically, in some implementations, the indication to skip PDCCH monitoring 208 can explicitly identify the UL sub-band or the time-frequency resource associated with the UL sub-band. Alternatively, in some implementations, the UE 104 can identify the time-frequency resource associated with the UL sub-band based on the SBFD configuration 206. For example, the configuration of UL sub-bands may be considered an implicit configuration to not monitor PDCCH in the one or more time-frequency resources associated with the one or more UL sub-band(s) if such UL sub-bands overlap with DRX active time. That is, if only a first configuration (e.g., SBFD configuration 1 or SBFD configuration 2) is provided by the network, the UE implicitly applies the new DRX behavior (i.e., the UE does not monitor PDCCH in the one or more time-frequency resources associated with one or more UL sub-band(s)). The UE can do so for both short and long DRX, as well as if DCP or LP-WUS is configured.

At 212, the UE 104 can refrain from monitoring the PDCCH for a duration of a UL sub-band. That is, based on the SBFD configuration, the UE 104 may refrain from monitoring those time-frequency resources within active time (e.g., during the running of drx-onDuration or drx-Inactivity timers etc.) where at least one UL sub-band is configured. In some implementations, a running timer (e.g., a DRX timer such as drx-onDuration or drx-Inactivity) can be stopped for those slots that are configured with UL sub-bands by the network in order to cause the UE 104 to refrain from PDCCH monitoring. Alternatively, in some implementations, the timer may continue to run as per legacy DRX configuration, but the UE 104 can refrain from monitoring the PDCCH while the timer runs based on the indication to skip PDCCH monitoring 208 (e.g., the time-frequency resources associated with DL reception that are part of the DRX active time). Additionally, the UE may go into micro, light, deep or ultra-deep sleep in those time-frequency resources where it does not monitor PDCCH (provided the UE has no other pending/ongoing transmission), depending on the wake-up time to switch back to PDCCH monitoring.

As described herein, a “micro sleep” mode can refer to an operating state for short DRX cycles in connected mode DRX (C-DRX). For example, the UE may briefly power down receiver between consecutive PDCCH monitoring instances within a short cycle (e.g., for a few milliseconds, etc.), thereby maintaining responsiveness for downlink activity with minimal latency. A “light sleep” mode can refer to a C-DRX operating state for longer C-DRX cycles or idle mode with frequent paging. For example, the UE may deactivate down most of its receiver circuitry for longer intervals between control channel monitoring (e.g., 10s or 100s of milliseconds, etc.). A “deep sleep” mode can refer to a C-DRX operating state with relatively long paging cycles. For example, the UE may monitor only the Paging Occasions (POs) based on configured DRX cycles (e.g., waiting seconds between monitoring). An “ultra deep sleep mode can refer to a C-DRX operating state with long DRX cycles or extended idle/inactive states. For example, the UE can enter a sleep mode for minutes or hours.

In some implementations, the network may explicitly configure the UE 104 to stop monitoring PDCCH in the UL sub-band or the time-frequency resources associated with the UL sub-band(s) via the indication to skip PDCCH monitoring 208. Specifically, in some implementations, the network may provide the UE with a first configuration which includes the SBFD configuration 206 (e.g., SBFD configuration 1, configuration 2, etc.) and then provide the UE with the indication to skip PDCCH monitoring for the UL sub-band(s). If the UE 104 “expects” the indication to skip PDCCH monitoring 208, an absence of the indication to skip PDCCH monitoring 208 can indicate to the UE 104 to follow legacy PDCCH monitoring behavior within DRX active time.

In some implementations, the SBFD configuration 206 and/or the indication to skip PDCCH monitoring 208 can configure the UE 104 with different CORESETs and/or search space sets such that the one or more UL sub-bands that are configured within the DL or flexible slot that fall within the UE's DRX active time need not be monitored for PDCCH candidates. That is, the SBFD-aware UE can be provided with a CORESET/search space set configuration such that the one or more time-frequency resources associated with one or more UL sub-band(s) need not be monitored by the UE for PDCCH candidates.

In some implementations, the UE 104 can be configured with one or more BWPs for each link direction (e.g., UL or DL). Generally, only one BWP can be active for each link direction at a given time. However, if the UE 104 supports more than one active BWP in each link direction, the UE 104 can be provided with a PDCCH skipping configuration 208 such that the time-frequency resource associated with UL sub-band(s) corresponding to DL BWP(s) may be deactivated, if the one or more time-frequency resources fall within DRX active time.

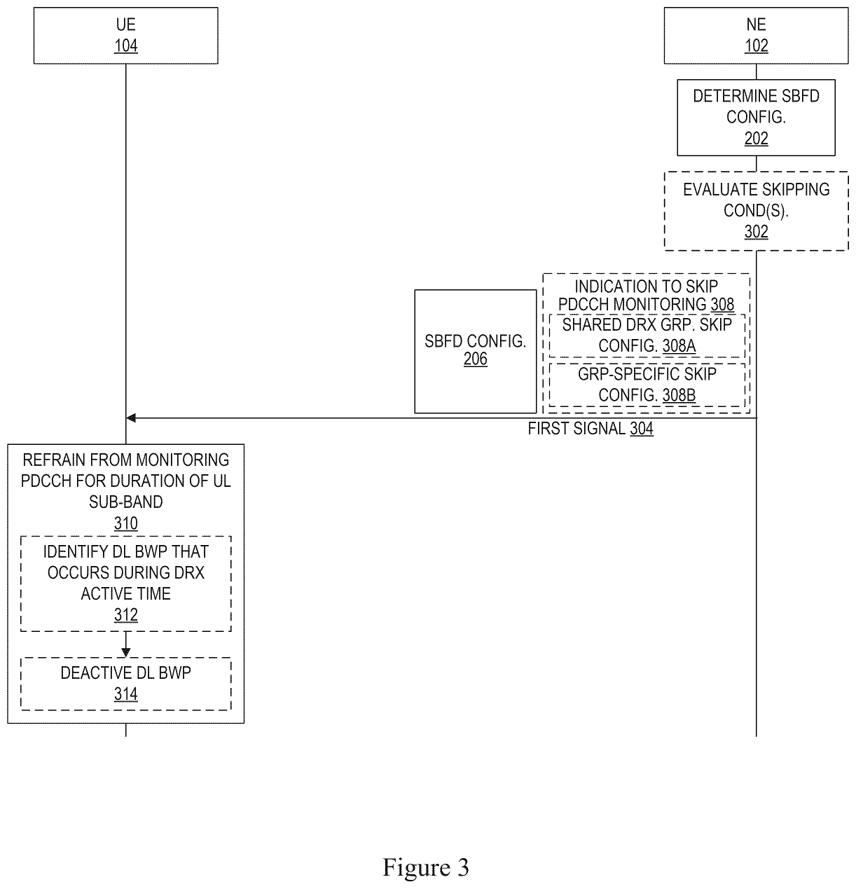

FIG. 3 is a communication flow diagram for granular control channel skipping decisions in SBFD with shared or group-specific DRX configuration in accordance with aspects of the present disclosure. FIG. 3 will be discussed in conjunction with FIGS. 1 and 2. More specifically, at 202, the NE 102 can determine a SBFD configuration 206 for the UE 104 as described with regards to FIG. 2.

At 302, in some implementations, the NE 102 can evaluate PDCCH skipping conditions. In some implementations, the PDCCH skipping conditions can include a size of the UL sub-band. A minimum UL sub-band size threshold may be defined by the NE 102 (e.g., the minimum number of RBs in a UL sub-band or a percentage of the total number of RBs within slot) such that if the size of UL sub-band configured to the UE 104 satisfies this minimum UL sub-band size threshold, the SBFD-aware UE applies the PDCCH skipping behavior in the one or more time-frequency resources associated with one or more UL sub-band(s). In some implementations, if the UE 104 is one of a cell of UEs, only a subset of the UEs in the cell that satisfy the one or more of the conditions configured may apply the indication to skip PDCCH monitoring 208.

Additionally, or alternatively, in some implementations, the PDCCH skipping conditions can include a traffic type expected for the UE. A “traffic type”, as described herein, can refer to a latency sensitivity of the data, an “importance” or priority of the data, etc. If the network determines that the DL data available for the UE is “lower” priority (e.g., based on a value such as a perceptual stability index (PSI) value of mixed reality (XR) data), the network may configure the UE 104 to follow the indication to skip PDCCH monitoring in the one or more time-frequency resources associated with one or more UL sub-band(s).

Additionally, or alternatively, in some implementations, if a UE is configured with two TDD patterns (e.g., in tdd-UL-DL-ConfigurationCommon), the PDCCH skipping conditions can include the TDD pattern. For example, when the UE 104 is configured with the PDCCH skipping configuration 208, the UE may refrain from monitoring the PDCCH only within either one of the TDD patterns or across both TDD patterns. For example, a flag may be introduced within the tdd-UL-DL-ConfigurationCommon IE to indicate to the UE 202 within which TDD pattern the indication to skip PDCCH monitoring 208 can be applied. When the flag is set to true for a pattern, the indication to skip PDCCH monitoring 208 is applied in the one or more time-frequency resources associated with one or more UL sub-band(s) for that TDD pattern. If the flag is set to false, the UE 104 may monitor for PDCCH as per legacy DRX configuration. Alternatively, the absence of such a flag may also imply that the UE 104 follows legacy DRX operation. For example, the below tdd-UL-DL-ConfigurationCommon IE is provided as a non-limiting example of an IE that can be used to convey the TDD pattern skipping condition to the UE:

| | |
|---|---|
| ASN1START | |
| TAG-TDD-UL-DL-CONFIGCOMMON-START | |
| TDD-UL-DL-ConfigCommon : := | SEQUENCE { |
| referenceSubcarrierSpacing | SubcarrierSpacing, |
| pattern1 | TDD-UL-DL-Pattern, |
| pattern2 | TDD-UL-DL-Pattern |
| OPTIONAL, -- Need R | |
| . . . | |
| } | |
| TDD-UL-DL-Pattern : := | SEQUENCE { |
| dl-UL-TransmissionPeriodicity | ENUMERATED {ms0p5, |
| ms0p625, ms1, ms1p25, ms2, ms2p5, ms5, ms10}, | |
| nrofDownlinkSlots | INTEGER |
| ( 0..maxNrofSlots), | |
| nrofDownlinkSymbols | INTEGER |
| (0..maxNrofSymbols-1), | |
| nrofUplinkSlots | INTEGER |
| (0..maxNrofSlots), | |
| nrofUplinkSymbols | INTEGER |
| (0..maxNrofSymbols-1), | |
| sbfd-DL-SkippingPattern1 | ENUMERATED {true} |
| OPTIONAL, | |
| sbfd-DL-SkippingPattern2 | ENUMERATED {true} |
| OPTIONAL, | |
| . . ., | |
| [[ | |
| dl-UL-TransmissionPeriodicity-v1530 | ENUMERATED {ms3, |
| ms4} | OPTIONAL - |
| -Need R | |
| ]] | |
| } | |
| TAG-TDD-UL-DL-CONFIGCOMMON-STOP | |
| ASN1STOP | |

At 304, the NE 102 can signal an indication to skip PDCCH monitoring 308 to the UE 104 alongside the SBFD configuration 206. For example, the indication to skip PDCCH monitoring 308 can be provided alongside the SBFD configuration 206 (e.g., in system information, RRC configuration, etc.). The indication to skip PDCCH monitoring 308 can be the same as the indication to skip PDCCH monitoring 208 of FIG. 2, except the indication to skip PDCCH monitoring 308 can include a shared DRX group skipping indication 308A or a group-specific skipping indication 308B.

More specifically, the UE 104 may be configured with dual DRX groups where the drx-onDuration timer, drx-Inactivity timer and lpwus-PDCCHMonitoring timer may be separately configured with either the same or different timer values for each DRX group. In such instances, the UE 104 can be provided the shared DRX group skipping indication 308A. The UE 104 can monitor PDCCH differently in each of the DRX groups based on the duration of the configured timers. In some instances, if the UE 104 is configured with dual DRX groups, the UE 104 can also be configured (either implicitly or explicitly) to not monitor PDCCH in the one or more time-frequency resources associated with one or more UL sub-band(s) within DRX active time. In some implementations, skipping behavior may be configured separately for each DRX group. For example, the UE 104 may be configured in one DRX group to refrain from monitoring the PDCCH in the one or more time-frequency resources associated with one or more UL sub-band(s) within DRX active time, while the UE 104 may not be configured to refrain from monitoring the PDCCH in the other DRX group.

Alternatively, in some implementations, the UE 104 may be provided with a common configuration across both DRX groups to refrain from monitoring PDCCH in the time-frequency resources associated with one or more UL sub-band(s) within DRX active time. For example, if the UE 104 is configured to refrain from monitoring the PDCCH in the one or more time-frequency resources associated with one or more UL sub-band(s) within the first DRX group, the UE will also follow the same behavior in the second DRX group.

At 310, the UE 104 can refrain from monitoring the PDCCH for the duration of the UL sub-band. In some implementations, to do so, at 312, the UE can identify a DL BWP that occurs during DRX active time, and at 314, the UE 314 can deactivate the DL BWP. For example, assume the UE is configured with a first set of BWPs for UL and a second set of BWPs for DL. The UL sub-band can correspond to one or more of the second set of BWPs for DL. To refrain from monitoring the PDCCH for the duration of the UL sub-band, the UE 104 can identify the first BWP of the second set of BWPs for DL that occurs during the DRX active time, and then deactivate the first BWP that occurs during the DRX active time. Alternatively, the operations performed during steps 312 and 314 can be performed without configuration of dual DRX groups.

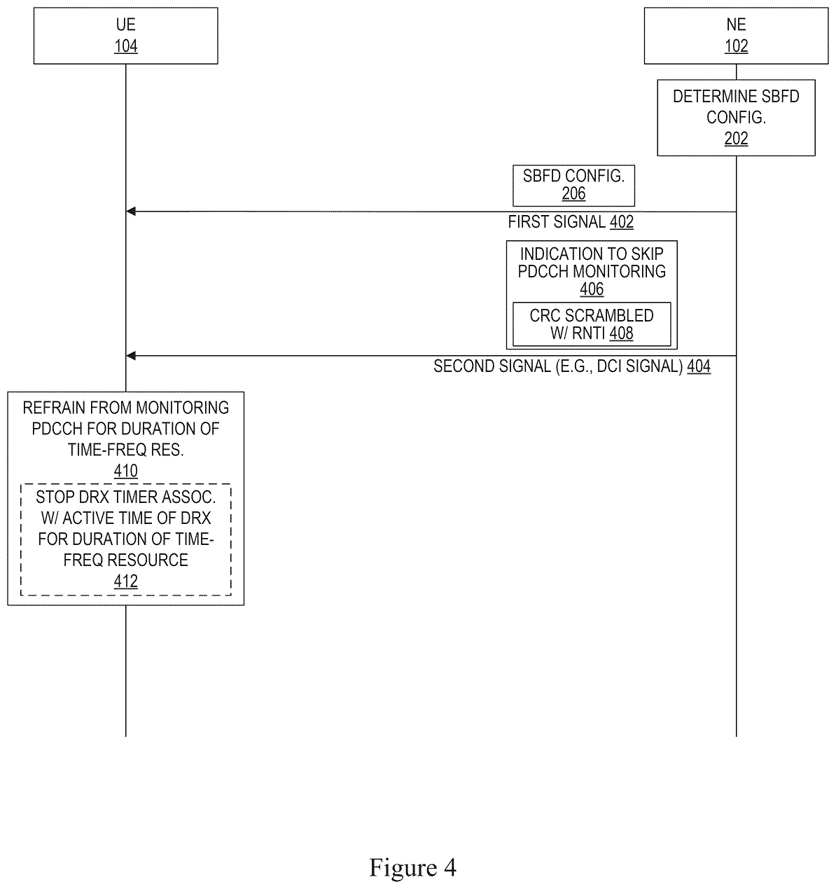

FIG. 4 is a communication flow diagram for granular control channel skipping decisions in SBFD with explicit indication to skip PDCCH monitoring in accordance with aspects of the present disclosure. FIG. 4 will be discussed in conjunction with FIGS. 1-3. More specifically, at 202, the NE 102 can determine a SBFD configuration 206 for the UE 104 as described with regards to FIG. 2.

At 402, the NE 104 can signal the SBFD configuration 206 to the UE 104 via a first signal as described with regards to FIGS. 1-3.

At 404, the NE 104 can signal an indication to skip PDCCH monitoring 406 to the UE 104. The indication to skip PDCCH monitoring 406 can include a CRC. For example, the second signal 404 may be a DCI signal that includes a CRC. The CRC can be scrambled with an RNTI assigned to the UE 104. The UE 104 can utilize the RNTI to unscramble the CRC to refrain from monitoring the PDCCH for the duration of the time-frequency resource.

At 410, the UE 104 can refrain from monitoring the PDCCH for the duration of the UL sub-band. In some implementations, at 412, to do so, the UE can stop, for the duration of the UL sub-band (or the time-frequency resource associated with the UL sub-band), a DRX timer associated with an active time of the DRX. Stopping the DRX timer can cause the UE to refrain from monitoring the PDCCH for the duration of the UL sub-band.

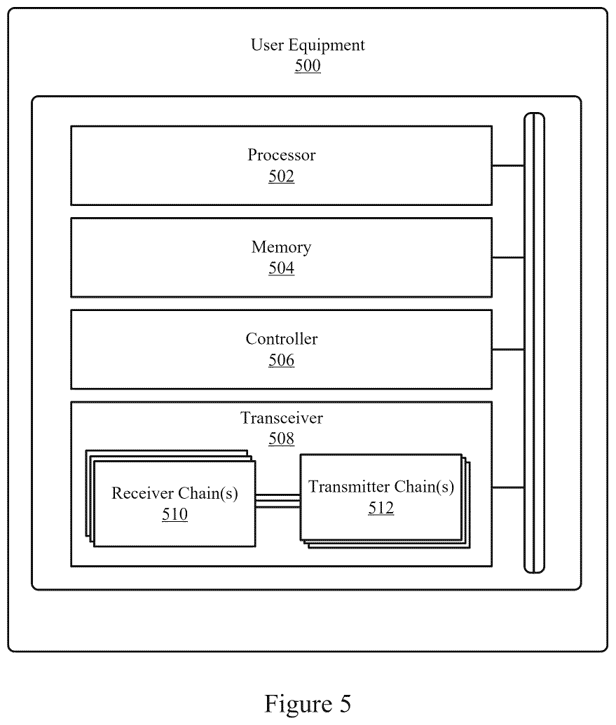

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to support a means for receiving, from a network entity, one or more signals indicative of a SBFD configuration and an indication to skip PDCCH monitoring during a UL sub-band; and, refrain from monitoring the PDCCH for the duration of the UL sub-band.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing of the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

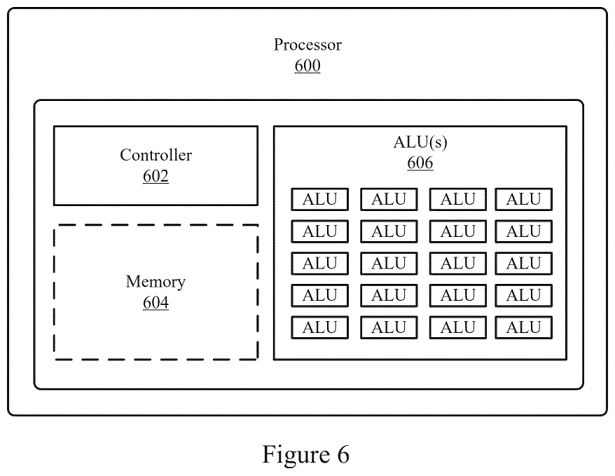

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track the memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 can be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support a means for receiving, from a network entity, one or more signals indicative of a SBFD configuration and a configuration for skipping monitoring of a PDCCH, the configuration being indicative of a time-frequency resource associated with a UL sub-band of a plurality of time-frequency resources of the SBFD configuration; and, based on the configuration for skipping monitoring of the PDCCH, refraining from monitoring the PDCCH for a duration of the time-frequency resource associated with the UL sub-band.

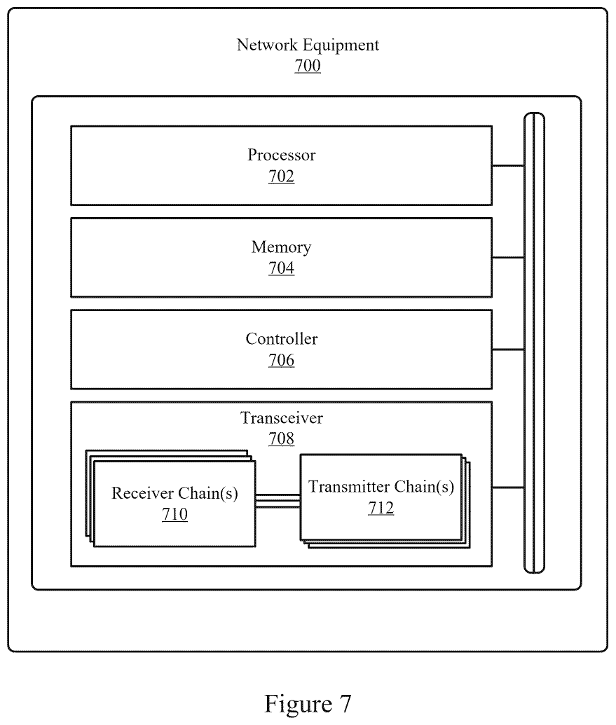

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to support a means for determining a SBFD configuration comprising one or more of DL sub-bands, UL sub-bands; and sending, to one or more UEs, the SBFD configuration and an indication to skip monitoring the PDCCH during a duration of an UL sub-band.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing of the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

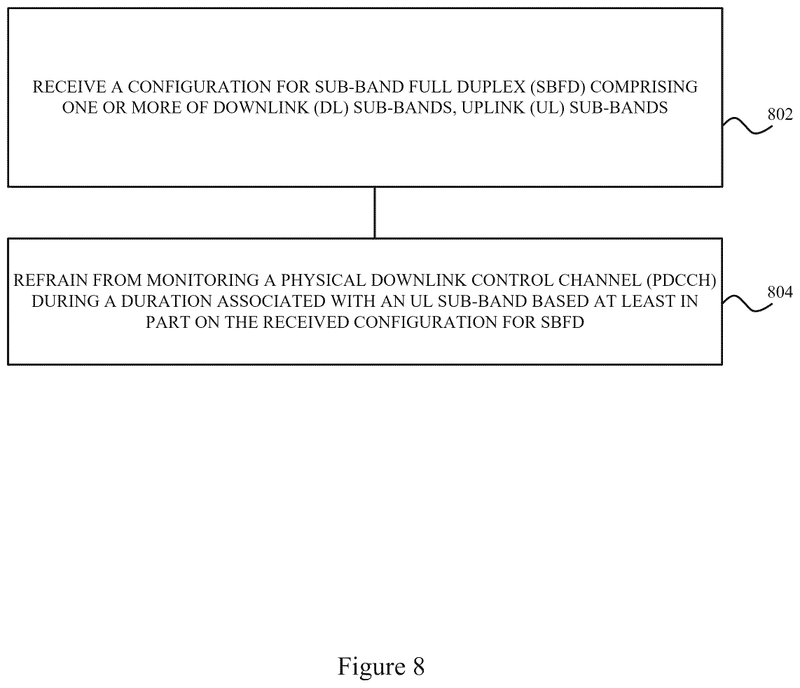

FIG. 8 illustrates a flowchart of a method in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include receive a configuration for SBFD comprising one or more of DL sub-bands, UL sub-bands. The operations of 802 may be performed in accordance with examples as described herein. In some implementations, aspects of the operations of 802 may be performed by a UE as described with reference to FIG. 5.

At 804, the method may include refraining from monitoring a PDCCH during a duration associated with an UL sub-band based at least in part on the received configuration for SBFD. The operations of 804 may be performed in accordance with examples as described herein. In some implementations, aspects of the operations of 804 may be performed by a UE as described with reference to FIG. 5.

In some instances, the method may include receiving an indication to skip monitoring the PDCCH, wherein to refrain monitoring the PDCCH is based at least in part on the received indication to skip monitoring the PDCCH.

In some instances, the method may include jointly receiving the configuration for SBFD and the indication to skip monitoring the PDCCH.

In some instances, the indication to skip monitoring the PDCCH is indicative of one or more skipping conditions, and the method may include determining that at least one of the one or more skipping conditions has been satisfied. In some instances, the skipping conditions comprise a minimum UL sub-band size, a DL traffic type, or a TDD configuration.

In some instances, one or more of the configuration for SBFD or the indication to skip monitoring the PDCCH is received in SI message, a RRC message, or a DCI.

In some instances, the indication to skip monitoring the PDCCH is received in DCI, wherein a CRC of the DCI is scrambled based on a RNTI. In some instances, the RNTI is associated with the UE or a group of UEs.

In some instances, the method may include performing a discontinuous reception (DRX) operation associated with a connected mode DRX based at least in part on absence of an indication to skip monitoring the PDCCH after reception of the configuration for SBFD.

In some instances, the method may include activating a sleep mode of the UE for the duration, wherein the sleep mode of the UE comprises: a micro-sleep mode, a light-sleep mode, a deep-sleep mode, or an ultra-deep sleep mode.

In some instances, to refrain from monitoring the PDCCH for the duration of the time-frequency resource associated with the UL sub-band, the method may include stopping, for the duration of the UL sub-band, a DRX timer associated with an active time of the DRX, wherein stopping the DRX timer causes the UE to refrain from monitoring the PDCCH for the duration of the UL sub-band.

In some instances, the UE is configured with a first set of BWPs for UL and a second set of BWPs for DL, wherein the UL sub-band corresponds to one or more of the second set of BWPs for DL, and wherein, to refrain from monitoring the PDCCH for the duration of the UL sub-band, the method may include identifying one or more BWPs of the second set of BWPs for DL that occurs during a DRX active time, and deactivating the one or more BWPs that occurs during the DRX active time.

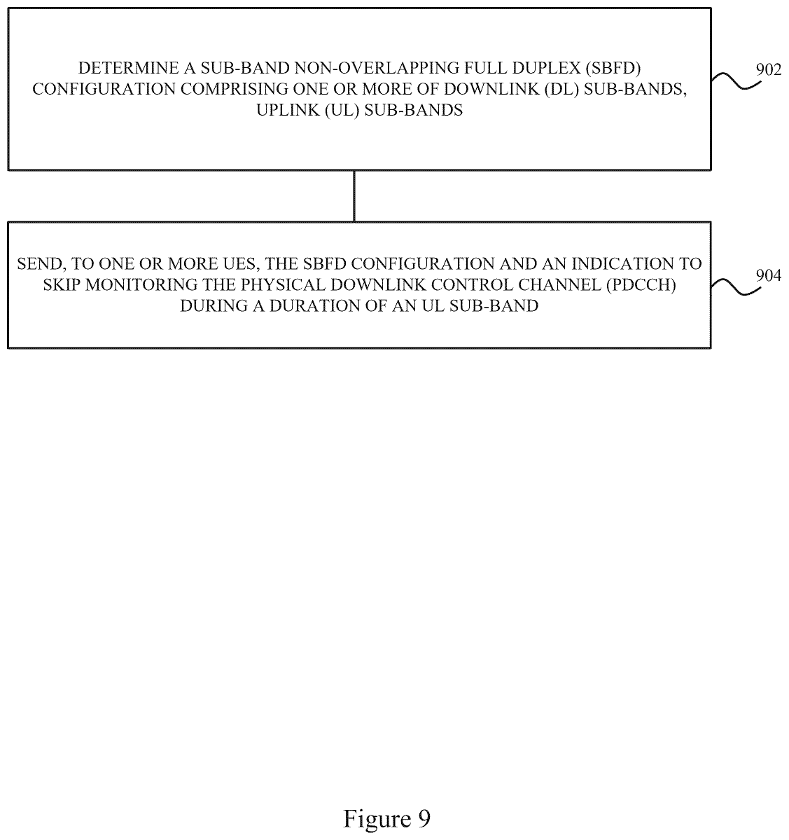

FIG. 9 illustrates a flowchart of a method in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include determining a SBFD configuration comprising one or more of DL sub-bands, UL sub-bands. The operations of 902 may be performed in accordance with examples as described herein. In some implementations, aspects of the operations of 902 may be performed by a NE as described with reference to FIG. 7.

At 904, the method may include sending, to one or more UEs, the SBFD configuration and an indication to skip monitoring the PDCCH during a duration of an UL sub-band. The operations of 904 may be performed in accordance with examples as described herein. In some implementations, aspects of the operations of 904 may be performed by a NE as described with reference to FIG. 7.

In some instances, the indication to skip monitoring the PDCCH is indicative of one or more skipping conditions.

In some instances, one or more of the configuration for SBFD or the indication to skip monitoring the PDCCH is sent in SI message, a RRC message, or a DCI.

In some instances, the indication to skip monitoring the PDCCH is sent in DCI, wherein a CRC of the DCI is scrambled based on a Radio Network Temporary identifier RNTI.

In some instances, the RNTI is associated with at least one of the one or more UEs.

The following provides an overview of aspects of the present disclosure:

Embodiment 1: A method performed or performable by a UE, comprising:
receive a configuration for sub-band full duplex (SBFD) comprising one or more of downlink (DL) sub-bands, uplink (UL) sub-bands; and
refrain from monitoring a physical downlink control channel (PDCCH) during a duration associated with an UL sub-band based at least in part on the received configuration for SBFD.

Embodiment 2 includes the method of embodiment 1. In this embodiment, the method includes:
receiving an indication to skip monitoring the PDCCH; and
wherein to refrain monitoring the PDCCH is based at least in part on the received indication to skip monitoring the PDCCH.

Embodiment 3 includes the method of any of embodiments 1-2. In this embodiment, the method includes jointly receiving the configuration for SBFD and the indication to skip monitoring the PDCCH.

Embodiment 4 includes the method of any of embodiments 1-3. In this embodiment, the indication to skip monitoring the PDCCH is indicative of one or more skipping conditions, and the method includes determining that at least one of the one or more skipping conditions has been satisfied.

Embodiment 5 includes the method of any of embodiments 1-4. In this embodiment, the skipping conditions can include a minimum UL sub-band size, a DL traffic type, or a TDD configuration.

Embodiment 6 includes the method of any of embodiments 1-5. In this embodiment, one or more of the configuration for SBFD or the indication to skip monitoring the PDCCH is received in system information (SI) message, a Radio Resource Control (RRC) message, or a downlink control information (DCI).

Embodiment 7 includes the method of any of embodiments 1-6. In this embodiment, the indication to skip monitoring the PDCCH is received in DCI, wherein a Cyclic Redundancy Check (CRC) of the DCI is scrambled based on a Radio Network Temporary identifier (RNTI).

Embodiment 8 includes the method of any of embodiments 1-7. In this embodiment, the RNTI is associated with the UE or a group of UEs.

Embodiment 9 includes the method of any of embodiments 1-8. In this embodiment, the method includes performing a discontinuous reception (DRX) operation associated with a connected mode DRX based at least in part on absence of an indication to skip monitoring the PDCCH after reception of the configuration for SBFD.

Embodiment 10 includes the method of any of embodiments 1-9. In this embodiment, the method includes activating a sleep mode of the UE for the duration, wherein the sleep mode of the UE comprises: a micro-sleep mode, a light-sleep mode, a deep-sleep mode, or an ultra-deep sleep mode.

Embodiment 11 includes the method of any of embodiments 1-10. In this embodiment, the duration associated with the UL sub-band comprises a duration of a time-frequency resource, comprising a symbol, a slot, a RB, or a BWP.

Embodiment 12 includes the method of any of embodiments 1-11. In this embodiment, to refrain from monitoring the PDCCH for the duration of the UL sub-band, the method includes stopping, for the duration of the UL sub-band, a DRX timer associated with an active time of the DRX, wherein stopping the DRX timer causes the UE to refrain from monitoring the PDCCH for the duration of the UL sub-band.

Embodiment 13 includes the method of any of embodiments 1-12. In this embodiment, the UE is configured with a first set of BWPs for UL and a second set of BWPs for DL, wherein the UL sub-band corresponds to one or more of the second set of BWPs for DL, and wherein, to refrain from monitoring the PDCCH for the duration of the UL sub-band, the method includes identifying one or more BWPs of the second set of BWPs for DL that occurs during a DRX active time and deactivating the one or more BWPs that occurs during the DRX active time.

Embodiment 14 relates to a UE for wireless communication, including one or more memories and one or more processors coupled with the one or more memories and individually or collectively operable to cause the UE to perform the method described in any of embodiments 1 to 13.

Embodiment 15: A method performed or performable by a NE, comprising:
determining a sub-band non-overlapping full duplex (SBFD) configuration comprising one or more of downlink (DL) sub-bands, uplink (UL) sub-bands; and
sending, to one or more UEs, the SBFD configuration and an indication to skip monitoring the physical downlink control channel (PDCCH) during a duration of an UL sub-band.

Embodiment 16 includes the method of embodiment 17. In this embodiment, the indication to skip monitoring the PDCCH is indicative of one or more skipping conditions.

Embodiment 17 includes the method of any of embodiments 15-16. In this embodiment, the one or more skipping conditions comprise a minimum UL sub-band size, a DL traffic type, or a Time Division Duplex (TDD) configuration.

Embodiment 18 includes the method of any of embodiments 15-17. In this embodiment, one or more of the configuration for SBFD or the indication to skip monitoring the PDCCH is sent in system information (SI) message, a Radio Resource Control (RRC) message, or a downlink control information (DCI).

Embodiment 19 includes the method of any of embodiments 15-18. In this embodiment, the indication to skip monitoring the PDCCH is sent in DCI, wherein a Cyclic Redundancy Check (CRC) of the DCI is scrambled based on a Radio Network Temporary identifier (RNTI).

Embodiment 20 includes the method of any of embodiments 15-19. In this embodiment, the RNTI is associated with at least one of the one or more UEs.

Embodiment 21 relates to a NE for wireless communication, comprising one or more memories and one or more processors coupled with the one or more memories and individually or collectively operable to cause the UE to perform the method described in any of embodiments 15 to 20.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The description provided herein, along with the accompanying figures, illustrates certain example implementations and is not intended to encompass all possible implementations within the scope of the claims. As used herein, the term “example” is intended to convey an illustration or instance, and does not imply a preferred or superior implementation. The detailed description includes specific features and elements to facilitate understanding of the implementations described in the present disclosure. However, these implementations may also be realized without some or all of the specified details.

What is claimed is:

1. A User Equipment (UE) for wireless communication, comprising:
one or more memories; and
one or more processors coupled with the one or more memories and individually or collectively operable to cause the UE to:
receive a configuration for sub-band full duplex (SBFD) comprising one or more of downlink (DL) sub-bands, uplink (UL) sub-bands; and
refrain from monitoring a physical downlink control channel (PDCCH) during a duration associated with an UL sub-band based at least in part on the received configuration for SBFD.

2. The UE of claim 1, wherein the one or more processors are further individually or collectively operable to cause the UE to:
receive an indication to skip monitoring the PDCCH,
wherein to refrain monitoring the PDCCH is based at least in part on the received indication to skip monitoring the PDCCH.

3. The UE of claim 2, wherein the one or more processors are further individually or collectively operable to cause the UE to:
jointly receive the configuration for SBFD and the indication to skip monitoring the PDCCH.

4. The UE of claim 2, wherein the indication to skip monitoring the PDCCH is indicative of one or more skipping conditions, and wherein the one or more processors are further individually or collectively operable to cause the UE to:
determine that at least one of the one or more skipping conditions has been satisfied.

5. The UE of claim 4, wherein the one or more skipping conditions comprise:
a minimum UL sub-band size;
a DL traffic type; or
a Time Division Duplex (TDD) configuration.

6. The UE of claim 2, wherein one or more of the configuration for SBFD or the indication to skip monitoring the PDCCH is received in system information (SI) message, a Radio Resource Control (RRC) message, or a downlink control information (DCI).

7. The UE of claim 6, wherein the indication to skip monitoring the PDCCH is received in DCI, wherein a Cyclic Redundancy Check (CRC) of the DCI is scrambled based on a Radio Network Temporary identifier (RNTI).

8. The UE of claim 7, wherein the RNTI is associated with the UE or a group of UEs.

9. The UE of claim 1, wherein the one or more processors are further individually or collectively operable to cause the UE to:
perform a discontinuous reception (DRX) operation associated with a connected mode DRX based at least in part on absence of an indication to skip monitoring the PDCCH after reception of the configuration for SBFD.

10. The UE of claim 1, wherein, to refrain from monitoring the PDCCH, the one or more processors are further individually or collectively operable to cause the UE to:
activate a sleep mode of the UE for the duration, wherein the sleep mode of the UE comprises: a micro-sleep mode, a light-sleep mode, a deep-sleep mode, or an ultra-deep sleep mode.

11. The UE of claim 1, wherein the duration associated with the UL sub-band comprises a duration of a time-frequency resource, comprising:
a symbol;
a slot;
a resource block (RB); or
a bandwidth part (BWP).

12. The UE of claim 1, wherein, to refrain from monitoring the PDCCH for the duration of the UL sub-band, the one or more processors are further individually or collectively operable to cause the UE to:
stop, for the duration of the UL sub-band, a DRX timer associated with an active time of the DRX, wherein stopping the DRX timer causes the UE to refrain from monitoring the PDCCH for the duration of the UL sub-band.

13. The UE of claim 1, wherein the UE is configured with a first set of BWPs for UL and a second set of BWPs for DL, wherein the UL sub-band corresponds to one or more of the second set of BWPs for DL, and wherein, to refrain from monitoring the PDCCH for the duration of the UL sub-band, the one or more processors are further individually or collectively operable to cause the UE to:
identify one or more BWPs of the second set of BWPs for DL that occurs during a DRX active time; and
deactivate the one or more BWPs that occurs during the DRX active time.

14. A method performed or performable by a user equipment (UE), comprising:
receiving, by the UE from a network entity, configuration for sub-band full duplex (SBFD) comprising one or more of downlink (DL) sub-bands, uplink (UL) sub-bands; and
refraining from monitoring a physical downlink control channel (PDCCH) during a duration associated with an UL sub-band based at least in part on the received configuration for SBFD.

15. A network entity for wireless communication, comprising:
one or more memories; and
one or more processors coupled with the one or more memories and individually or collectively operable to cause the network entity to:
determine a sub-band non-overlapping full duplex (SBFD) configuration comprising one or more of downlink (DL) sub-bands, uplink (UL) sub-bands; and
send, to one or more UEs, the SBFD configuration and an indication to skip monitoring the physical downlink control channel (PDCCH) during a duration of an UL sub-band.

16. The network entity of claim 15, wherein the indication to skip monitoring the PDCCH is indicative of one or more skipping conditions.

17. The network entity of claim 16, wherein the one or more skipping conditions comprise:
a minimum UL sub-band size;
a DL traffic type; or
a Time Division Duplex (TDD) configuration.

18. The network entity of claim 15, wherein one or more of the configuration for SBFD or the indication to skip monitoring the PDCCH is sent in system information (SI) message, a Radio Resource Control (RRC) message, or a downlink control information (DCI).

19. The network entity of claim 18, wherein the indication to skip monitoring the PDCCH is sent in DCI, wherein a Cyclic Redundancy Check (CRC) of the DCI is scrambled based on a Radio Network Temporary identifier (RNTI).

20. The network entity of claim 19, wherein the RNTI is associated with at least one of the one or more UEs.
